(19) United States
(12) Patent Application Publication
(10) Pub. No.: US 2008/0127249 A1
(43) Pub. Date: May 29, 2008

(54) System and method for encouraging advertisement viewing

(76) Inventor: David A. Cruice, Plantation, FL (US)

Correspondence Address: EDWARDS ANGELL PALMER & DODGE LLP, P.O. BOX 55874, BOSTON, MA, 02205, US

(21) Appl. No.: 11/521,005

(22) Filed: Sep. 14, 2006

(51) Int. Cl. H04N 7/10

(52) U.S. Cl. 725/34

(57) ABSTRACT

In accordance with the invention, household-specific demographic data is entered onto a server. Digital advertisements are uploaded on the server, the digital advertisements being targeted to specific households as a function of the demographic data. Household target and time data is assigned to each specific advertisement. The advertisement is then forwarded to television companies for transmission in accordance with the target and time data. A viewer is prompted for a manual response during transmission of the advertisement. The television company monitors a manual response during transmission of the advertisement and the targeted household is rewarded as a function of the monitored manual response.

### BACKGROUND OF THE INVENTION

This invention is directed to the monitoring of television viewership, and more particularly, a method and apparatus for encouraging viewers to view advertisements on television.

In the current television advertising model, a potential advertiser is able to determine the general demographic of an overall audience through the advent of monitoring services such as that provided by Nielsen Media Research (“Nielsen”). Nielsen is able to provide general statistics about the projected audience for a particular channel during a particular time period and general demographics such as gender and age within a range. An advertiser, such as an automaker, wanting to advertise to that demographic or a subset of that demographic such as 18-25 year old males pays a price based upon overall viewership, i.e., the total audience.

Reference is now made to FIG. 1 wherein a schematic diagram of the prior art television model is provided. The television content 500 includes programming 502 separated by a commercial break 504 made up of a queue of advertisements 506. An automobile manufacturer 520 wishing to advertise to the advertising market 522 selects a time slot 506′ for an advertisement placement within commercial break 504.

To the television company, the television network sees the entire market of 500,000 potential viewers. However, the automobile manufacturer 520 is directing its message to a subset or target market 524 of overall advertising market 522; a market share of 15% or 75,000 viewers in our example. Because the advertising automobile manufacturer 520 is in fact purchasing the entire advertising market, the cost per viewer for the entire advertising market may be relatively low, but the cost per viewer of the target market will be relatively high because of the inefficiencies. By way of example, if the advertiser pays $25,000 for the 30-second slot, the television network perceives being paid 20¢ per viewer whereas the automobile manufacturer 520 perceives a cost of 33¢ per viewer for its anticipated target market. Therefore, as can be seen, there is an inefficiency.

Although satisfactory, there are various shortcomings to this system. First, even if there was a good faith belief that viewers within that demographic were actually watching advertisements, there are great inefficiencies to the advertisers by paying advertising dollars based upon an overall audience in which their target of interest may be a subset of that audience. Secondly, with the advent of interactive digital television and digital video recorders, it has become possible to monitor when viewers are skipping advertisements by fast forwarding through the advertisement or “channel surfing” during the advertisement, but there is no way to track whether viewers are actually watching the advertisement or have left the room during the advertisement.

As a result of this inefficiency, during the last few years, television advertising has declined as advertising dollars have flowed to media in which actual viewership may be monitored, such as the Internet. With Internet advertising, through the tracking of “click through” interaction with advertising campaigns, there is some assurance that the advertisement has been not only viewed, but acted upon by the Internet audience. The rise of companies such as Google and Yahoo! bears testimony to the value that advertisers place on being able to track the effectiveness of their advertising campaigns and calculate the return on investment through website visits and click through activity that is more directly related to purchases.

Technology has been developed, such as targeted television advertising to identified households, to partially overcome the advertiser's dilemma of the inefficient purchase of advertising time based upon overall demographics. Such technology is currently, or will soon be, offered by Comcast Cable in partnership with TANDBERG Television while Cablevision partnered with Visible Worldwide. Therefore, it becomes ever more important to ensure that the advertisements are actually viewed. Accordingly, a system and method which overcomes the shortcomings of the current advertising model is provided.

### BRIEF SUMMARY OF THE INVENTION

In accordance with the invention, household-specific demographic data (including a television address) is entered onto an ad targeting server. Digital advertisements are uploaded on the server. The digital advertisements are targeted to specific households as a function of the demographic data. Household target data (which may include presentation time) is assigned to each specific advertisement. The advertisement is then forwarded to network programming servers affiliated with television companies for transmission in accordance with the target data. A viewer is prompted for a manual response during transmission of the advertisement. The ad targeting server monitors a manual response during transmission of the advertisement and the targeted household is rewarded as a function of the monitored manual response.

In one embodiment of the invention, the ad targeting server monitors web search activity of the household and further customizes the household demographic data as a function of the web searching activities of the household. In another embodiment, the ad targeting server will communicate with potential advertisers and provide “send advertisement” icons on the advertiser website so that interested parties may communicate to the ad targeting server to receive advertisements from that company.

In a further embodiment of the invention, an auction will be held to determine which advertisement is assigned a specific advertisement slot as a function of household demographic data, date, time and position in queue.

### BRIEF DESCRIPTION OF THE DRAWINGS

For a fuller understanding of the invention, reference is had to the following description taken in connection with the following drawings in which:

FIG. 1 is a schematic view of an advertising targeting model in accordance with the prior art;

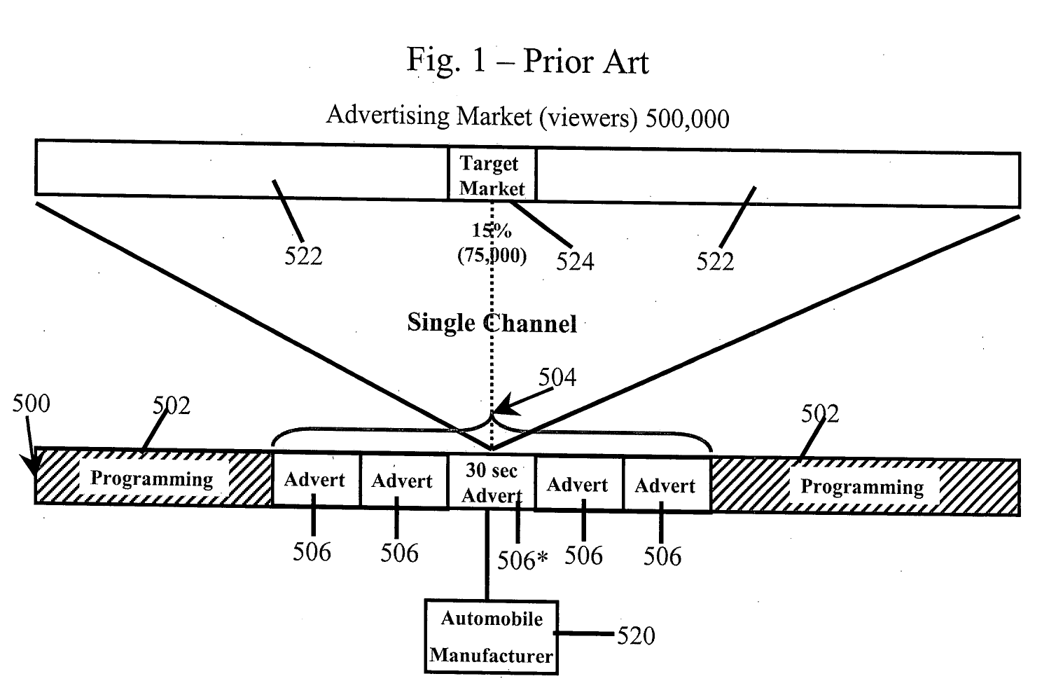

FIG. 2 is a system flow diagram for delivering advertisements in accordance with the present invention;

FIG. 3 is a flow chart for encouraging advertisement viewing in accordance with the present invention; and

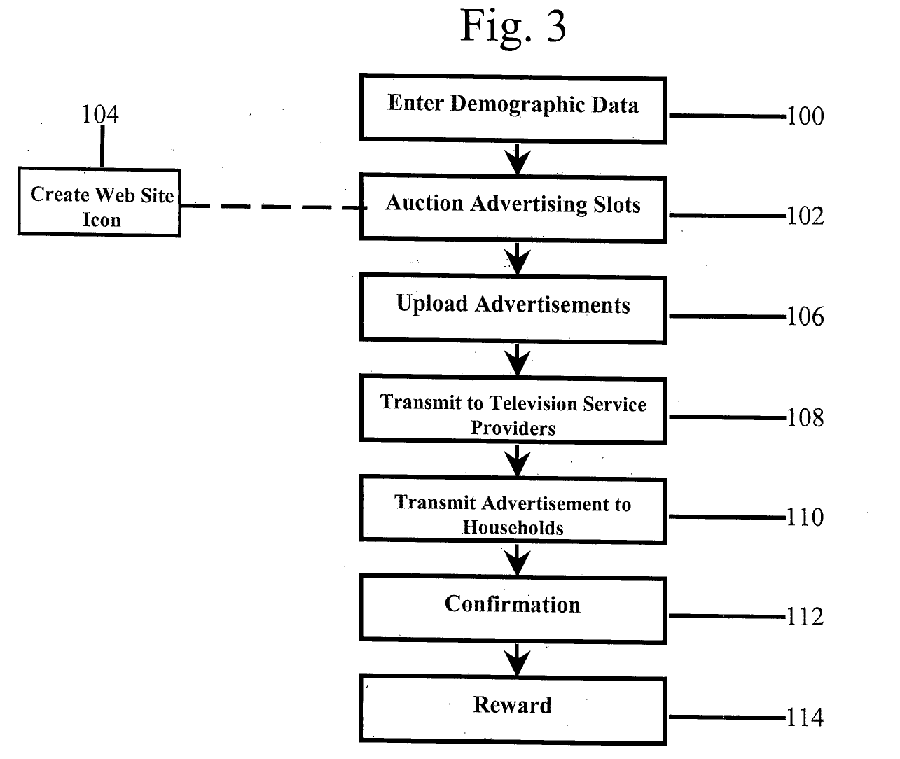

FIG. 4 is a schematic representation of an advertising model in accordance with the present invention.

### DETAILED DESCRIPTION OF THE INVENTION

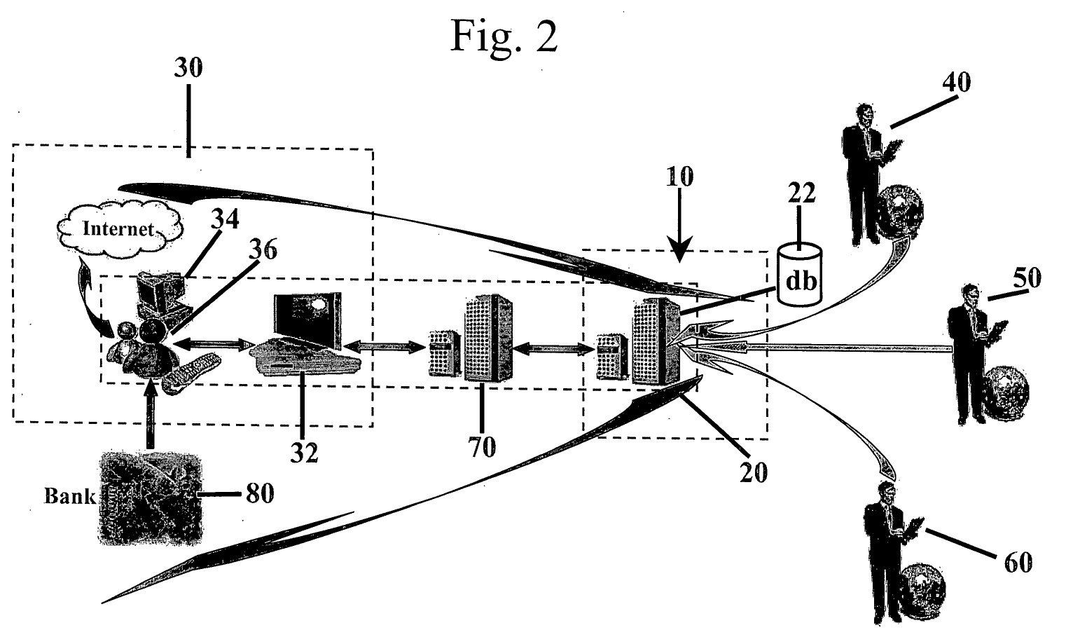

Reference is now made to FIG. 2 in which a system, generally indicated as 10, constructed in accordance with the invention is provided. System 10 includes a targeting server, generally indicated as 20, associated with a database 22. Targeting server 20 communicates with a television programming network server 70 associated with one or more television networks for controlling programming sent to household 30. Targeting server 20 also communicates with a home-based remote computer 34, and remote servers/computers 40, 50 and 60 of advertisement sources (alternatively referred to as source companies and advertising agencies) such as corporations and advertising agencies. Programming network server 70 communicates with an addressable, interactive television 32, preferably by way of non-limiting example, a digital television. Targeting server 20 also communicates with a bank 80, which in turn communicates with a household 30.

A household 30 includes addressable interactive television 32 capable of being viewed by a plurality of viewers 36 which view the content provided on a plurality of channels at television 32. Television 32 may include a digital video recorder for recording the content provided by programming network servers 70 for later viewing by viewers 36.

During use, demographic data is entered at targeting server 20 regarding household 30 in a step 100. This information may include by way of non-limiting example the household street address, the household television address, the number of occupants of household 30, the gender of each occupant, the race of each occupant, the birthdates of each occupant and the annual income of each occupant. This data may be entered manually at targeting server 20 from information taken from signup cards or the like at the time of purchase of the service, or, may be entered electronically from household computer 34 over the Internet directly to ad targeting server 20 in an alternative embodiment.

In a preferred, non-limiting exemplary embodiment, household 30 may authorize targeting server 20 to monitor the Internet activity of household computer 34. Server 20 periodically captures the Internet “surfing activity”. The period for reviewing the activity may be daily, weekly, monthly or any repeatable time period. Surf activity is a good indicator of current interests, particularly, when “surfing” e-commerce sites for purchases. This information is then used to further customize the demographic data for a particular household 30 stored at database 22 by incorporating the interests of viewers 36 as determined from the Internet activity.

Advertisements generally are sourced to television companies from companies 40, 60 or from advertising agencies 50. When contracting with television service networks, corporations 40, 60 or their ad agencies 50 determine their target audience and then indicate to the television networks when and where the advertisement should be displayed. It should be noted that “where” in the television sense corresponds not only to geographical regions within a broadcast reception area, but to date, time and/or specific channels known under trade names such as CBS, Sci-Fi, Discovery, or the like within the television bandwidth. Furthermore, it is known in the art to group commercials at industry-standard breaks within the program content provided at each channel so that two or more commercials may be queued in a row for presentation during a single commercial break.

In accordance with the present invention, because the commercials are targeted to specific television 32, corresponding to a specific household 30, advertisement providers may bid on specific households in combination with specific delivery slots for the advertisement in a step 102. Each advertising space will be auctioned as a function of target demographic data and at least one of time, date, and position within the transmission queue and channel or even specific program. As a result of the auction, advertising targeting server 20 assigns the advertisement slot for the targeted household 30 to the winning bidder.

In an alternative embodiment, although not mutually exclusive, advertisements may be placed as a function of household request. In a step 104, ad source 40, 50, 60 creates a complimentary website. By way of example, it may be the website for an automaker, a local restaurant, or an airline associated with servers 40, 50, 60 by way of non-limiting examples. Access to the website is available, as known in the art, from household computer 34 across the Internet. The website may be hosted at advertising targeting server 20 or at a servers 40, 50, 60 associated with advertising sources.

A website icon is provided at the website; the icon being interactive. The icon corresponds to the request from household 30 to be sent a television advertisement associated with the company creating the website. By selecting the icon with household computer 34, a signal is sent to advertising targeting server 20 and/or advertising providers 40, 50, 60 indicating that an advertisement is requested. This advertisement may then be placed for a fixed a fee or may be subject to auction in accordance with step 102.

In a step 106, advertisements are uploaded from servers 40, 50, 60 located at corporations, advertising agencies or small businesses to targeting server 20. Server 20 assigns a television address associated with a particular household 30, and if part of targeting, time, date and queue position information associated with the advertisement as a result of the auction process or the predetermined assignment from steps 102, 104. It should be noted, that not every slot be independently auctioned. A weighting system within a particular queue or particular hour block of time may be up for auction in which the highest bidder gets its selection of address, time, and place within the queue and the second highest bidder is assigned the second most valuable advertising slot in accordance with its parameters.

In this way, advertising agencies 50 can upload digital advertisements on behalf of clients to targeting server 20. It should be noted that the bid for advertising slots may occur before or after the uploading of the advertisement. Additionally, because the assignment process and the ability to direct digitally download advertisements, businesses 40, 60 may bypass the use of advertising agencies to determine the best placement.

Lastly, as a result of the icon placement and bidding process, small businesses may now have the opportunity to reach their customers by television advertisements. Small businesses may upload digital advertisements to server 20 and then, to limit costs, request that advertisements be sent only to customers who have requested to receive their advertisements in step 104 or bid for narrowly broadcast slots by narrowing the demographics in which they are interested as part of the auction process.

In a step 108, the advertisements along with the targeting data (address and one of time, position in queue, associated programming or the like) are transferred from advertising targeting server 20 to programming network server 70. As a result, the cable and satellite companies will now be in receipt of address and time data associated with advertisements which will identify the household 30 to which the advertisement should be sent to along with the date and time range that the advertisement should be played.

In a preferred non-limiting embodiment, television 32 includes digital video recording capabilities. The advertisements may be stored on a digital video recording device associated with television 32 to be played during normal commercial breaks during the time specified by the advertisers as a function of the targeting data associated with the advertisement. Cable and satellite companies having video on demand and other digital capabilities will be able to use their existing communications infrastructure to forward the targeted advertisement to the appropriate targeted household 30 without reliance on the digital video recording capabilities of television 32.

In a step 112, viewers 36 may confirm their presence in front of television 32 during the playing of advertisements. This may be done by entering a randomly generated alphanumeric confirmation code into the television that corresponds to a number appearing on the screen in one preferred, but non-limiting, embodiment. This confirmation code may appear at random either before, during or after advertisements have played. The code may be entered into the television by utilization of a television remote control device or any other signaling device interactive with household television 32. The confirmation of the viewing will then be transmitted to television network programming server 70, which in turn transmits the confirmation to ad targeting server 20.

Confirmation may occur on a timeslot-by-timeslot basis, a commercial-by-commercial basis or a random combination thereof to prevent tricking the system by a viewer 36 determining when interaction is required and returning to the television only at those times. The confirmation along with advertisement identifiers are stored in database 22.

The fact that in some instances the advertisements have been specifically requested by household 30 and in others have been specifically targeted based upon known viewer interest and demographics, may be sufficient to encourage advertiser viewership. However, it is contemplated in a step 114 that viewers 36 at household 30 be rewarded for advertising viewership. Therefore, upon confirmation of advertising viewership, targeting server 20 causes a reward to be made available to user 36. This may be a direct cash payment from ad directing server 20 to a bank 80 associated with household 30. Bank 80 is any entity capable of transmitting value in money, credits, goods or services or the like to household 30.

It is well known in the art that advertisers pay for placement of advertising. However, in accordance with the invention, a portion of those funds is now diverted to viewer 36 to reward actual viewing of the advertisement. Rewards can be passed through the television service providers by way of a credit towards the monthly bill as recorded by network programming server 70, or may take the form of “in-kind” coupons directed to household computer 34 from the advertising source computers 40, 50, 60. It is also contemplated that the level of reward may be variable. Some advertisers may be willing to pay more for certain viewers 36 and viewer 36 may share in the premium to further encourage advertisement viewing. Also, a premium may be paid to viewer 36 as a function of the amount of demographic data disclosed to targeting server 20.

As a result of confirming advertising viewership, advertisers can now better determine the efficiency of advertising dollars. In this model, the viewer only gets rewarded for actual confirmed viewing of advertisements. Conversely, because viewership is being confirmed, it is within the scope of this invention that advertisers can determine actual advertising viewership and pay reduced rates as a function of actual advertisement viewing. In other words, rather than flat fee payments with some adjustment as is traditional in the television advertising business, an advertisement pay-per-view paradigm or a hybrid thereof in which a minimal flat fee is paid for the use of the network and incremental payments are made as a function of actual confirmed viewers can be implemented.

Furthermore, it should be noted with system 10, because a queue of advertisements targeted for specific households is stored at the household television 32 or within network programming server 70, the target data may include an instruction that the queue of commercials be played at the next available viewed commercial break ensuring that the commercials are seen in the purchased order by the targeted household regardless of time, date or channel. In this way, if targeted household 30 does not make use of its television 32 because they are on vacation, or have random viewing patterns, then it will be ensured that the commercials are eventually delivered to household television 32 at the next available viewing or the next viewing at the purchased time of day.

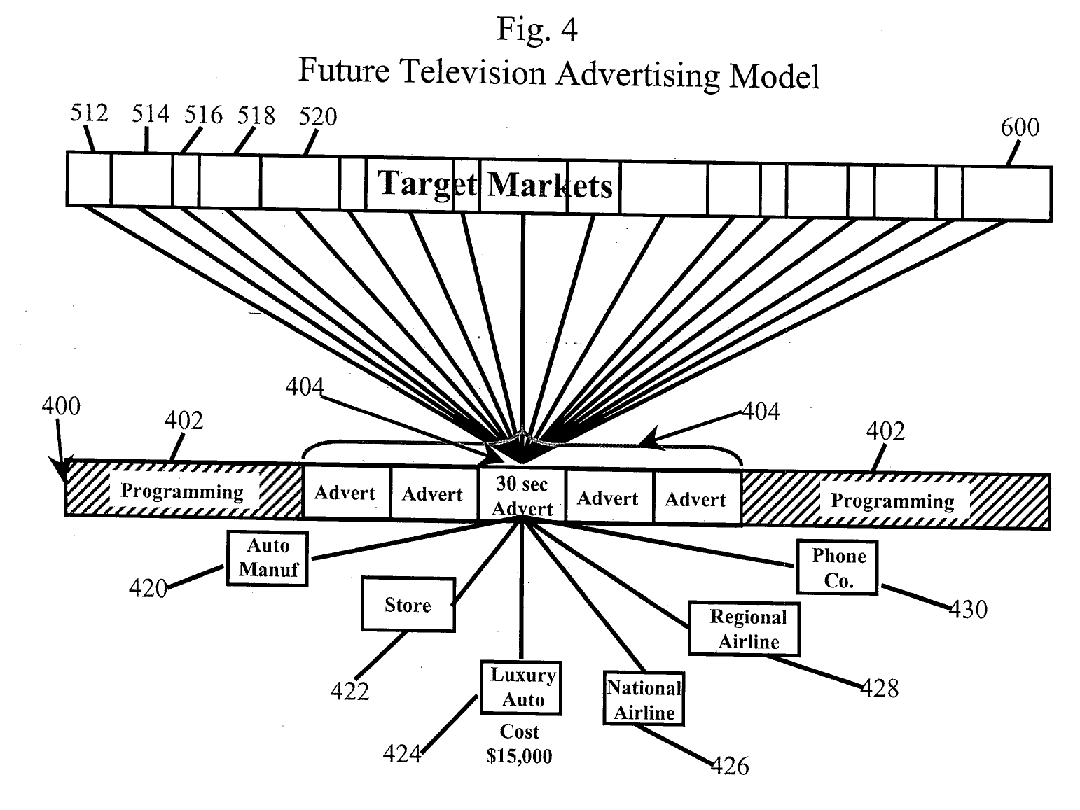

The effect of the novel advertising method and system is expansion of advertising revenue for programming providers with a simultaneous reduction of advertising cost to advertisers. Referring now to FIG. 4 in which a schematic diagram of the advertising model for specific advertising time slots in accordance with the invention is provided. As discussed above, television content 400 includes programming 402 provided by programming network server 70 broken up with a commercial break 404 made up of a queue of advertisements disposed between programming events 402. The target market 410 is made up of a number of grouped or individual targeted households 512-600. For ease of description, a single 30-second advertisement 406 is described. Advertisement 406, now is considered a timeslot rather than a specific advertisement content because a plurality of different advertisers 420-430 can direct an individual 30-second advertisement 406 to individually targeted households 512-600.

By way of example, based upon demographics, a seller of mid-priced automobiles 420 may wish to target households 512, 514, while a luxury auto dealer 424 may wish to place an advertisement at the same time but directed at households 516, 518, so that the total market of 500,00 viewers in our example may be bifurcated into segmented targetable submarkets. Each of the advertisers only wishes to target a subset, perhaps a 100,000 viewers or 75,000 viewers out of the total market.

Similarly, a retail store 422 may wish to target all of the households having a certain budget or having expressed interest in the store so that its target may include all of households 512 through 518. Similarly, a national airline 426 may have a different target than a regional airline 428 and is now able to bid for timeslot 402 and specific targeted households 510. Whereas a phone company 430 may wish the entire market of households 512-600.

Each company would bid for the desired target as discussed above. Where there is no overlap, such as between auto manufacturers 420, 424, or very little overlap, a low price may ensue. However, where there may be competing interest in demographics such as between a phone company 430 and a national airline 426, the bidding process may in fact increase the price to the advertiser as compared to no competition. This maximizes revenue to the television networks for desirable targeted households and time slots. This increases the efficiency of the sale of advertising space.

It should be noted, for the example of this application, in the prior art, it was assumed that $25,000 would be paid for the entire 500,000 person market. However, for example with the auto manufacturer vendors 420, 424, under the prior art advertising scheme they are obviously paying for viewers in which they are not interested. In one example, if the cost per viewer for the luxury automaker, cost being targeted households that watch the advertisement is set at as much as 20¢ per viewer, then the cost to the high end manufacturer for their subset of the 500,000 viewers could be $15,000 for 75,000 targeted viewers. Conversely, given a viewership of 500,000 members, if fully subscribed, the network may sell the remaining targeted households and make as much as $100,000 for the one advertising slot 406. In comparison, under the old model, the sale of the same advertisement slot would have cost the luxury automaker, the only purchaser of the slot, significantly more, yet the yield to the television service providers would have been significantly less even accounting for any type of reward to the household.

It should be understood that ad targeting server 20 and network programming server 70 are indicated as two distinct entities. However, it is well within the scope of the invention for the two servers to be combined so that a single server combines the overall functionality into a single server. Furthermore, with addressable digital video recorders, it is also contemplated and well within the scope that the ads are downloaded directly from ad targeting server 20 to household television 32 and that the playing of the advertisements is triggered by a signal from network programming server 70 at the appropriate break in programming.

Thus, while there have been shown, described and pointed out novel features of the present invention as applied to preferred embodiments thereof, it will be understood that various omissions and substitutions and change in the form and detail are contemplated so that the disclosed invention may be made by those skilled in the art without departing from the spirit and scope of the invention. It is the intention therefore to be limited only as indicated by the scope of the claims appended hereto. It is also to be understood that the following claims are intended to cover all of the generic and specific features of the invention herein described and all statements of the scope of the invention, which, as a matter of the language, might be said to fall therebetween.

What is claimed as new and desired to be protected by Letters Patent of the United States is:

1. A method for encouraging household viewing of a television advertisement comprising the steps of:
entering household-specific demographic data onto an advertising targeting server;
uploading on said advertising targeting server digital advertisements targeted to specific households as a function of the demographic data;
assigning household target data to the advertisement as a function of the household-specific demographic data;
forwarding the advertisement to a household television in accordance with the household target data for viewing during a commercial break in television programming;
confirming viewing of the advertisement; and
rewarding the targeted household as a function of confirmation of viewing the advertisement.

2. The method of claim 1, further comprising the step of monitoring Internet activity associated with said household and customizing said demographic data as a function of the monitored Internet activity.

3. The method of claim 1, further comprising storing the advertisement and associated target data at one of a programming network server and a household television digital video recorder.

4. The method of claim 1, wherein said target data includes at least one of time data, date data, queue position data, and program content data.

5. The method of claim 1, further comprising providing a website accessible from a household, said website displaying an icon associated with an advertiser, and selecting said icon causing an instruction to be sent to said advertising targeting server to target a commercial associated with said website to said household.

6. The method of claim 1, further comprising the steps of conducting an auction among a plurality of advertisers, said plurality of advertisers bidding on said targeted households as a function of said demographic data to assign advertisements associated with said plurality of advertisers to specific targeted households.

7. The method of claim 1, wherein said confirmation includes monitoring a manual response occurring at the household during transmission of the advertisement.

8. The method of claim 7, wherein said manual response is entering a predetermined number at said household television during viewing of the advertisement.

9. The method of claim 1, wherein said reward is one of a cash payment, bill credit, or coupon.

10. A system for encouraging the viewing of television advertisements comprising:
an advertising targeting server, said advertising targeting server receiving demographic data and creating targeting data as a function thereof;
an advertising source server communicating with said advertising targeting server, said advertising source server loading a digital advertisement onto said advertising targeting server; and
a television disposed with a household, said advertising targeting server assigning target data to said advertisements and targeting said television as a function of said targeting data and causing said advertisement to be delivered to said television as a function of said targeting data by forwarding the advertisements to one of a programming network server and said television as a function of said targeting data, said advertising targeting server causing a reward to be given to said household in response to confirmation of viewing of said targeted advertisement.

11. The system of claim 10, further comprising a computer located at a household for communicating over the Internet, said advertising targeting server monitoring said computer and customizing said demographic data as a function of use of said computer on the Internet.

12. The system of claim 11, further comprising a website accessible from said computer, said website displaying an icon associated with an advertiser, wherein selection of said icon from said computer causes an instruction to be sent to said advertising targeting server to target a commercial associated with said website to a television located at a household associated with said computer.

13. The system of claim 10, further comprising a communication device for communicating with said television to confirm viewing of said targeted advertisement, said television sending a confirmation signal to said advertising targeting server.

14. The system of claim 13, wherein said communication device transmits a predetermined number to said television during display of said advertisement.

15. A method for encouraging household viewing of a television advertisement comprising the steps of:
entering household-specific demographic data onto an advertising targeting server;
monitoring Internet activity associated with said household and customizing said demographic data as a function of the monitored Internet activity;
uploading on said advertising targeting server digital advertisements targeted to specific households as a function of the demographic data;
conducting an auction among a plurality of advertisers to assign advertisements associated with said plurality of advertisers to specific targeted households, said advertisers bidding on specific households as a function of the demographic data and assigning household target data to the advertisement as a function of said auction; and
forwarding the advertisement to a household television in accordance with the household target data for viewing during a commercial break in television programming.

16. A method for encouraging household viewing of a television advertisement comprising the steps of:
providing a website accessible from a household, said website displaying an icon associated with an advertiser;
selecting said icon to cause an instruction to be sent to an advertising targeting server to target a commercial associated with said website to said household;
uploading on said advertising targeting server an advertisement associated with the advertiser;
assigning household target data corresponding to the household to the advertisement; and
forwarding the advertisement to a household television in accordance with the household target data for viewing during a commercial break in television programming.
